(19) United States
(12) Patent Application Publication
(10) Pub. No.: US 2025/0300372 A1
(43) Pub. Date: Sep. 25, 2025

(54) INSULATION PIERCING CONNECTOR

(71) Applicant: Panduit Corp., Tinley Park, IL (US)

(72) Inventor: Russell K. Morrow, Tinley Park, IL (US)

(73) Assignee: Panduit Corp., Tinley Park, IL (US)

(21) Appl. No.: 19/049,059

(22) Filed: Feb. 10, 2025

Related U.S. Application Data
(60) Provisional application No. 63/569,441, filed on Mar. 25, 2024.

(51) Int. Cl. H01R 4/2408; H01R 9/24

(52) U.S. Cl. CPC H01R 4/2408; H01R 9/2416

(57) ABSTRACT

An insulation piercing connector for a solar system install is provided that is installed easily and provides multiple connections, using industry standard connectors, and protects the internal components from the elements such as water infiltration and UV exposure.

### CROSS-REFERENCE TO RELATED APPLICATION(S)

This application claims benefit to U.S. Provisional Patent Application No. 63/569,441, filed Mar. 25, 2024, the entirety of which is hereby incorporated by reference herein.

### TECHNICAL FIELD

The present disclosure relates to an insulation piercing connector including features for a solar installation.

### BACKGROUND

In solar energy farm applications that include solar panels that are electrically coupled together to produce solar energy, there are long runs of large gauge conducting cables to which smaller gauge solar panel cables need to be connected (i.e., branches). To accomplish this, it is impractical to strip the insulation from the main run cable, so devising a way to pierce the insulation from the main run cable to connect the branch wires is desired. This connection should preferably be secure, easy to install, provide watertight tap connections, and protect the connection from outdoor elements.

### SUMMARY

According to one non-limiting exemplary embodiment of the present disclosure, an insulation piercing connector is provided, the insulation piercing connector comprising an enclosure including an insulation piercing blade, a terminal pin electrically coupled to the insulation piercing blade, and a connector receptacle configured to receive the terminal pin, wherein the connector receptacle is configured to couple with a connector plug to provide electrical coupling between the terminal pin and a tap wire connected to the connector plug. The insulation piercing connector further comprising a configured to form a main cable pathway with the enclosure, the main cable pathway configured to hold a main cable for receiving power from the tap wire.

According to one non-limiting exemplary embodiment of the present disclosure, an insulation piercing connector is provided, the insulation piercing connector comprising an enclosure comprising a first opening positioned at a first location, a second opening positioned at a second location, the enclosure configured to house: an insulation piercing blade assembly including a blade and a tab, wherein the blade is configured to protrude out the first opening, and a terminal block being electrically coupled to the tab of the insulation piercing blade, the terminal block including a port opening aligned with the second opening and configured to receive a conductor wire from a tap cable inserted through the second opening, and a cable clamp configured to be removably attached to the enclosure and form a main cable pathway with the enclosure for holding a main cable, wherein the blade is configured to protrude out the first opening and pierce an insulation jacket of main cable held within the main cable pathway.

A detailed description of this and other non-limiting exemplary embodiments of an insulation piercing connector and method for installing and using such insulation piercing connector is set forth below together with the accompanying drawings.

### BRIEF DESCRIPTION OF THE DRAWINGS

FIG. 1 illustrates a perspective view of an insulation piercing connector, according to a non-limiting exemplary embodiment of the present disclosure.

FIG. 2 illustrates a perspective exploded view showing portions of an enclosure and internal components of the insulation piercing connector shown in FIG. 1, according to a non-limiting exemplary embodiment of the present disclosure.

FIG. 3 illustrates a perspective exploded view showing portions of an enclosure and internal components of the insulation piercing connector shown in FIG. 1, according to a non-limiting exemplary embodiment of the present disclosure.

FIG. 4 illustrates a perspective exploded view showing components of connector receptacles being attached to the enclosure included in the insulation piercing connector shown in FIG. 1, according to a non-limiting exemplary embodiment of the present disclosure.

FIG. 5 illustrates a perspective exploded view showing how components of the insulation piercing connector shown in FIG. 1 may be assembled, according to a non-limiting exemplary embodiment of the present disclosure.

FIG. 6 illustrates a perspective view of the insulation piercing connector shown in FIG. 1 in an assembled state, according to a non-limiting exemplary embodiment of the present disclosure.

FIG. 7A illustrates a side view of the insulation piercing connector shown in FIG. 1 in a first step of a cable installation process, according to a non-limiting exemplary embodiment of the present disclosure.

FIG. 7B illustrates a side view of the insulation piercing connector shown in FIG. 1 in a second step of a cable installation process, according to a non-limiting exemplary embodiment of the present disclosure.

FIG. 8 illustrates a perspective view of the insulation piercing connector shown in FIG. 1 in a process for installing a tap wire, according to a non-limiting exemplary embodiment of the present disclosure.

FIG. 9 illustrates a perspective view of an insulation piercing connector including an alternative embodiment for components used to connect a tap wire to an enclosure of the insulation piercing connector, according to a non-limiting exemplary embodiment of the present disclosure.

FIG. 10A illustrates a perspective exploded view of the insulation piercing connector shown in FIG. 9 showing a first step in an installation of a tap wire to the enclosure, according to a non-limiting exemplary embodiment of the present disclosure.

FIG. 10B illustrates a perspective exploded view of the insulation piercing connector shown in FIG. 9 showing a second step in an installation of a tap wire to the enclosure, according to a non-limiting exemplary embodiment of the present disclosure.

### DETAILED DESCRIPTION

Detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

Described herein is an insulation piercing connector for a solar system install that is installed easily and provides multiple connections, using industry standard connectors, and protects the internal components from the elements such as water infiltration and UV exposure. The described insulation piercing connector provides a weather tight ultra-violet (UV) resistant enclosure which uses a threaded fastener to force metallic spikes through the insulating jacket of the main run cable. Those spikes connect to terminal pins for an electrical connector (e.g., terminal pins for electrically coupling to a MC4 connector) which then exit the enclosure through multiple electrical connector receptacles (e.g., MC4 receptacles) sealed and threaded into the enclosure. Although the insulation piercing connector is being described for a solar installation use case, the insulation piercing connector may be applied to other use cases as well, including, but not limited to, other high voltage cable installations that may be used for testing for the presence, or absence, of voltage.

Because there are a wide variety of main run cable sizes, the enclosure is capable of accommodating a range of cables having different conductor gauge thickness sizes. Having available cables having different attributes such as conductor sizes (e.g., 350 through 1250 kcmil), voltage ratings (e.g., 600, 1 k and 2 k volts), current ratings, and materials (e.g., copper or aluminum) make developing a product that can be used with the different cable attribute combinations challenging. The disclosed insulation piercing connector has been configured to accept these different cables that are used, for example, for outdoor service as shown by its achieved IP67 rating. To achieve this IP67 rating, the cable seals on the disclosed insulation piercing connector are thick and flexible enough to seal a wide variety of cable physical characteristics such as thickness as measured by a gauge rating or outside diameter (OD) measurement. A further advantage of the disclosed insulation piercing connector is that it includes features for enabling toolless installation, as will be described in more detail below.

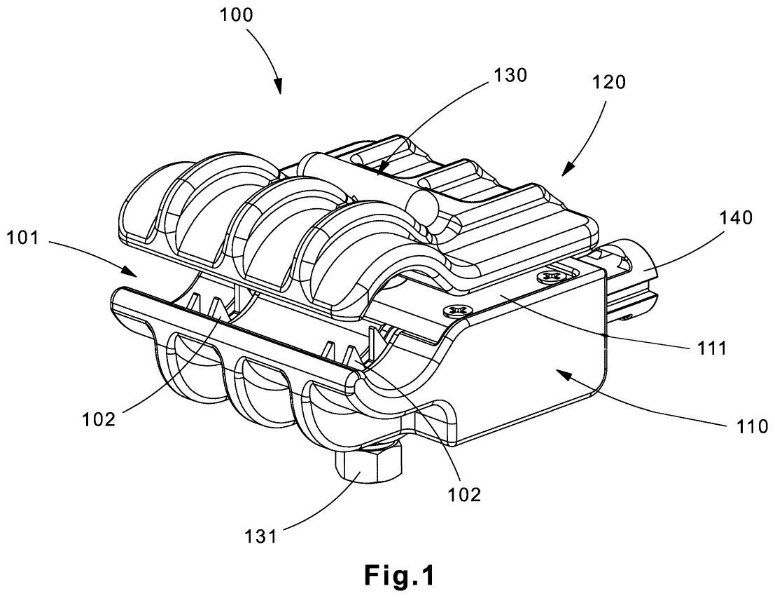

FIG. 1 shows an exemplary insulation piercing connector 100 that includes an enclosure 110, an enclosure cover 111, and cable clamp 120 that are molded with glass filled nylon. A space between the enclosure 110 and the cable clamp 120 forms a main cable pathway 101 configured to accommodate up to 750 kcmil cable. Within the main cable pathway 101 and on the enclosure 110, there are insulation piercing blades 102.

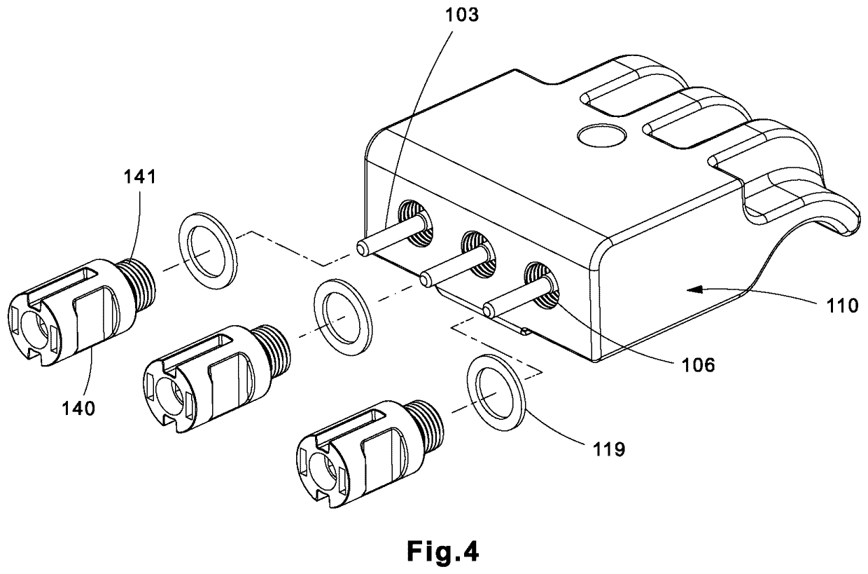

To enable toolless installation, the insulation piercing connector 100 includes a T-bolt 130 and nut 131 (e.g., breakaway torque limiting nut) for attaching the enclosure 110 and cable clamp 120 together in an assembled state. The insulation piercing connector 100 also includes three (3) electrical connector receptacles 140 (e.g., MP4 connector receptacles) which can accommodate, for example, up to 8 AWG code wire with photovoltaic (PV) grade insulation. The connector receptacles 140 are shown, for example, in the perspective view provided by FIG. 4.

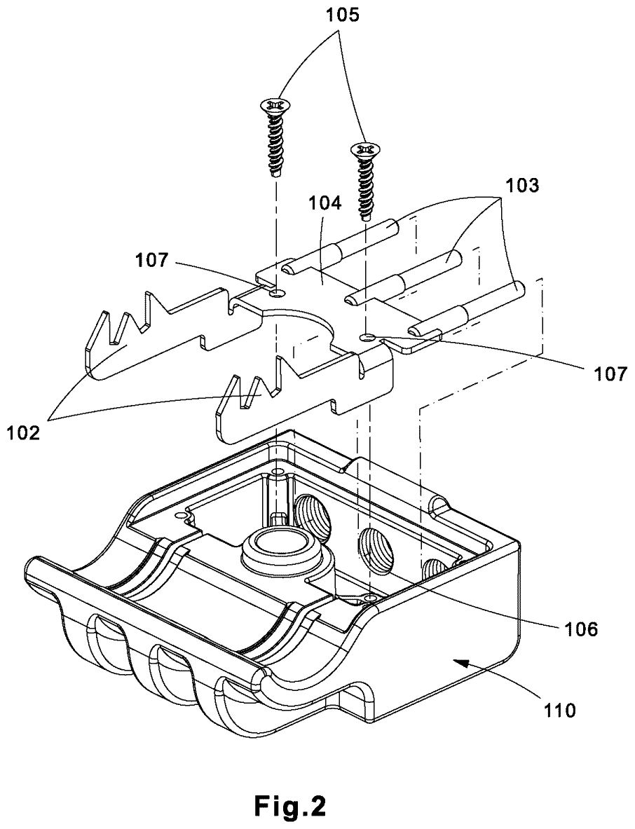

As shown in FIG. 2, inside of the enclosure 110 are the insulation piercing blades 102 that are secured to the enclosure by a pair of set screws 105 that are secured through holes 107 in a bus plate 104 portion of the insulation piercing blades 102. There (3) terminal pins 103 are soldered to the bus plate 104. The terminal pins 103 are configured to exit out respective tapped holes 106 in the enclosure 110 and be coupled with the connector receptacles 140 that are attached to the enclosure. The connector receptacles 140 are utilized to install tap wires for providing power from, for example, solar panels.

Thus an electrical circuit of the insulation piercing connector 100 is created by the electrical coupling of the terminal pins 103 being soldered to the bus plate 104 of the insulation piercing blades 102, so that when the spikes of the insulation piercing blades 102 pierce the insulation of a main cable to make contact with the conductor in the main cable, any power being supplied via tap cables connected to the connector receptacles 140 may flow through the terminal pins, through the bus plate 104, through the insulation piercing blades 102, and to the conductor in the main cable to supply power to the main cable.

The insulating piercing blades 102 are made from a conductive material such as copper. The insulation piercing blades 102 are configured to provide sufficient contact with a range of conductor wire sizes in the main cable, power ratings, and conductor materials for the main cable.

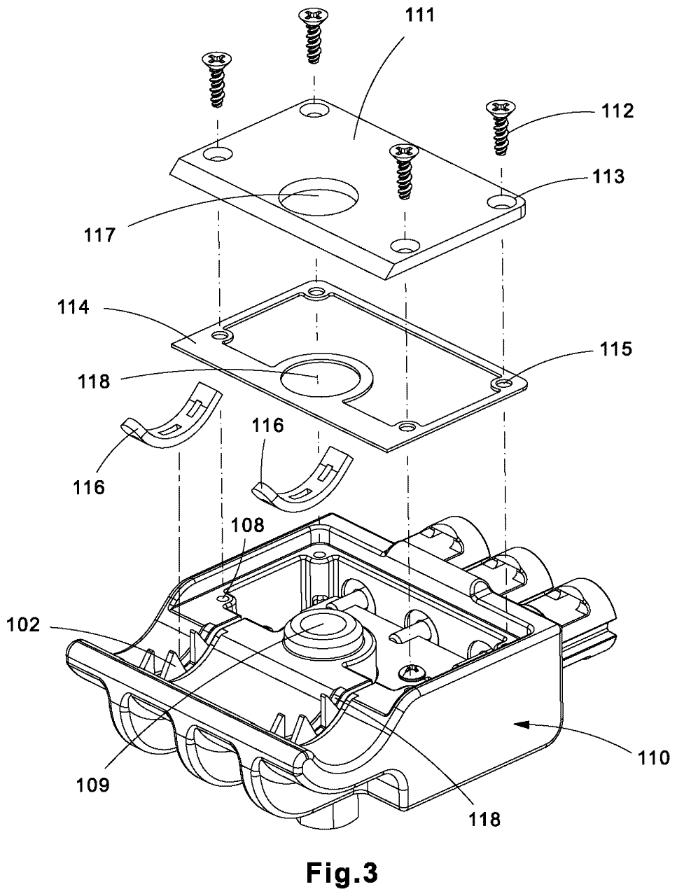

FIG. 3 shows an exploded view of the enclosure 110 to detail the assembly of some of the internal components comprising the enclosure 110. There may be various sealing elements utilized in the enclosure 110 for the enclosure 110 to achieve an IP67 rating. The first is a cover gasket 114 (e.g., a rubber cover gasket) that is placed just under the enclosure cover 111. Using four screws 112 (e.g., #6 screws) to pass through holes 113 at the corners of the enclosure cover 111 and holes 115 at the corners of the cover gasket 114, screwing down the screws 112 into post holes 108 in the enclosure 110 will press the cover gasket 114 between the enclosure cover 111 and against an enclosure face to create a seal that ensures moisture is kept out of the inside of the enclosure 110 where the insulation piercing blade 102 is housed.

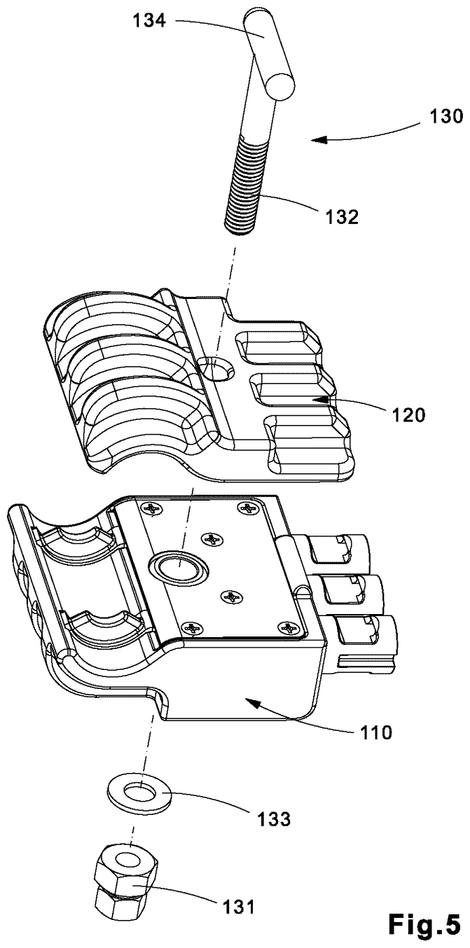

To seal around various cable sizes passing through the main cable pathway, blade groove seals 116 made out of flexible thick rubber are adhered into seal grooves 124 around the blade portions of the insulation piercing blades 102. As a main cable is pressed against the blades of the insulation piercing blades 102 which penetrate the insulation and contact a conductor in the main cable, the main cable (e.g., the outer insulation portions of the main cable) will contact the blade groove seals 116 and deform them to close any potential path for moisture into the inner housing of the enclosure 110 where the bus plate 104 is located. The T-bolt 130 is made to pass through an opening 123 in the cable clamp 120, an opening 117 in the enclosure cover 111, an opening 118 in the cover gasket 114, and an opening 109 in the enclosure 110, as will be described in more detail with the description of FIG. 5.

Another element utilized for sealing of the enclosure 110 are O-ring seals 119 used between the connector receptacles 140 and where they are installed against a wall of the enclosure 110, as shown in FIG. 4. The O-ring seals 119 may be rubber seals and will prevent moisture from entering the enclosure 110 via the tapped holes 106. FIG. 4 also shows a view that details how the connector receptacles 140 are installed to the enclosure 110. For example, threaded posts 141 on the connector receptacles 140 are screwed into threads of the tapped holes 106 to secure the connector receptacles 140 into the tapped holes and over the terminal pins 103, which also squeezes the O-ring seals 119 to create the described seal. After the connector receptacles 140 are secured to the enclosure 110, the terminal pins 103 will be positioned within the connector receptacles 140 so that tap wires (e.g., MC4 connector connected tap wires) that are later installed onto the connector receptacles 140 will be able to be easily electrically coupled to the terminal pins 103.

As shown in FIG. 5, the T-bolt 130 may be a ⅜″ T-head bolt including a cross bar handle 134 on one end, and a threaded portion 132 at an opposite end for having the nut 131 twisted around. The T-bolt 130 is inserted through the opening 123 in the cable clamp 120, the opening 117 in the enclosure cover 111, the opening 118 in the cover gasket 114, and the opening 109 in the enclosure 110. The cross bar handle 134 is shaped to be aligned with a groove molded into a body of the cable clamp 120. A flat washer 133 and the nut 131 are also shown in FIG. 5. Tightening the nut 131 draws the cable clamp 120 against the main cable sitting within the main cable pathway 101, forcing the main cable onto the spikes of the insulation piercing blades 102. Once sufficient force is applied to the main cable, the torque limit of the torque limiting nut 131 is exceeded and the unthreaded half of the nut 131 breaks off. This break away feature allows the installer to ensure that enough torque is applied using just their hands and/or standard installation tools, and without the need for separate specialized torque measuring tools.

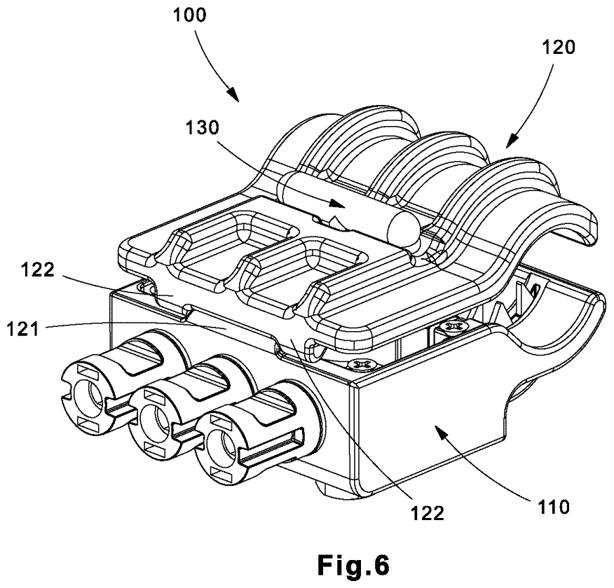

As shown in FIG. 6 the enclosure 110 also includes a centering tab 121 that is cast into the enclosure 110 and corresponding receiving tabs 122 on the cable clamp 120 for interlocking with each other. This feature is used to help align the cable clamp 120 with the enclosure 110 into an assembly comprising the insulation piercing connector 100. The faces of the tabs 121, 122 are cylindrical, so they are free to rotate as the cable clamp 120 is pulled against the main cable residing in the main cable pathway 101.

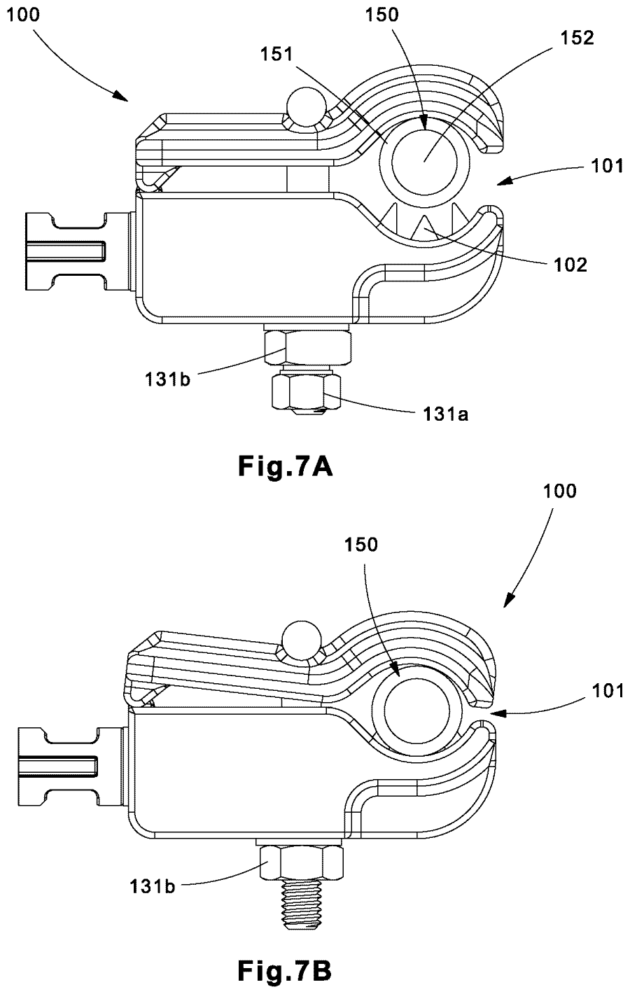

To connect the tap wires to the main cable run, the cable insulation on the main cable must be pierced. FIGS. 7A and 7B show an exemplary process for piercing an insulation layer 151 of a main cable 150, so that the insulation piercing blades 102 may electrically contact a conductor 152 inside the main cable 150. To begin the process, the outer spikes of the insulation piercing blade 102 must be centered with the main cable 150, as shown in FIG. 7A. With the cross bar handle 134 installed into the groove molded into the body of the cable clamp 120, a tool (e.g., a 9/16″ wrench) may be used to rotate the nut 131 (e.g., ⅜″ nut) clockwise to draw the cable clamp 120 towards the enclosure 110, thus clamping down on the main cable 150 residing within the main cable pathway 101. An outer hex 131a of the torque limiting nut 131 is smaller than a base hex 131b to ensure that the torque is only applied to the unthreaded portion of the nut 131. The nut 131 is continually rotated by applying a rotational force on the outer hex 131a until the outer hex 131a breaks away from the threaded portion of the torque limiting nut 131. This will ensure that the blade portion of the insulation piercing blades 102 has properly penetrated the insulation layer 151 and is now contacting the conductor 152 of the main cable 150, and that the blade groove seals 116 have been sufficiently deformed to create the described seal, as shown in FIG. 7B.

To loosen the insulation piercing connector 100 to remove the main cable 150, a wrench (e.g., an 11/16″ wrench) may be used to rotate the remaining base hex 131b counterclockwise, which will loosen the cable clamp 120 from the enclosure 110 until enough room is created within the main cable pathway 101 to remove the main cable 150.

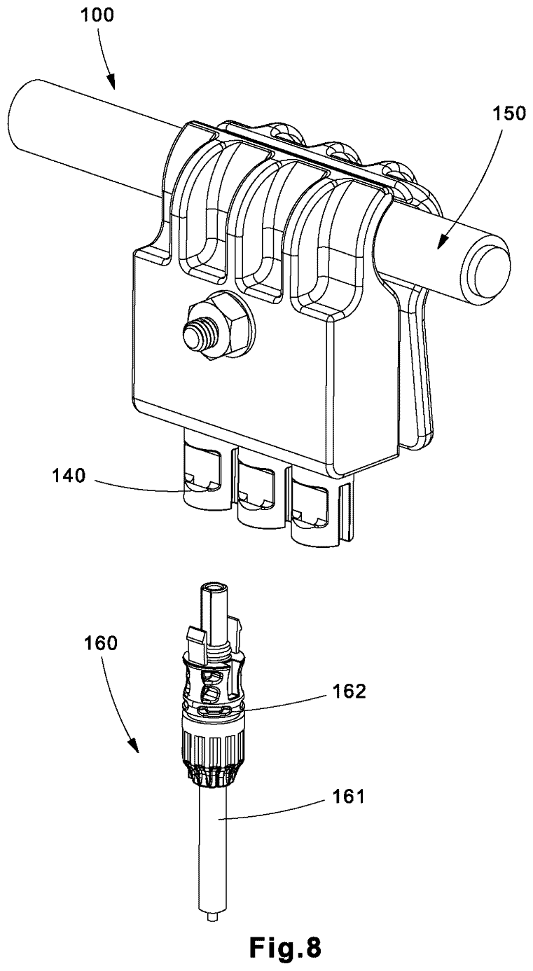

The components of the insulation piercing connector 100 are sized to allow for up to three tap wires 160 to be installed onto the three (3) connector receptacles 140 that are shown on the insulation piercing connector 100, as shown in FIG. 8. The tap wires 160 may be 8 AWG 2 kV wire. The tap wire 160 includes a cable portion 161 and a plug portion 162. The plug portion 162 is inserted into the connector receptacle 140 which are held in place with retaining clips included on the plug portion 162 and sealed with an O-ring seal that is an integral component of the plug portion 162. The plug portion 162 may be in the form of MC4 plugs for mating into the connector receptacle 140 when it is a MC4 type receptables.

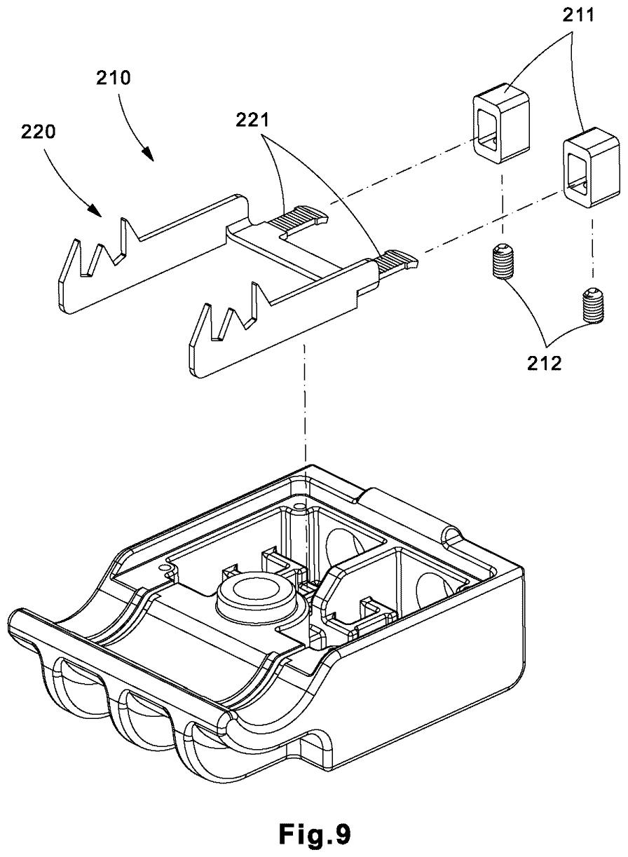

FIG. 9 shows an alternative embodiment of an enclosure 210 that includes an alternative tap wire connection feature from the design shown for the enclosure 110. The same cable clamp 120 may be used with the enclosure 210. This alternative embodiment of the enclosure 210 may be utilized when the specific type of tap wire connectors (e.g., MC4 style connectors) used in the enclosure 110 is not desired. So as an alternative, a terminal block arrangement can be employed in the enclosure shown in FIG. 9 that is not reliant on any specific connector type. The design of the enclosure 210 utilizes multiple cable glands and a screw applied terminal block. So as seen in FIG. 9, the enclosure 210 includes an insulation piercing blade 220, the insulation piercing blade 220 including a blade portion as well as insertion tabs 221. The enclosure 210 also includes terminal blocks 211 and set screws 212, where the insertion tabs 221 are configured to fit into openings of the terminal blocks 211 and be held within the openings by tightening the set screws 212 up into the opening space to secure the insertion tabs 221 inside the openings of the terminal blocks 211.

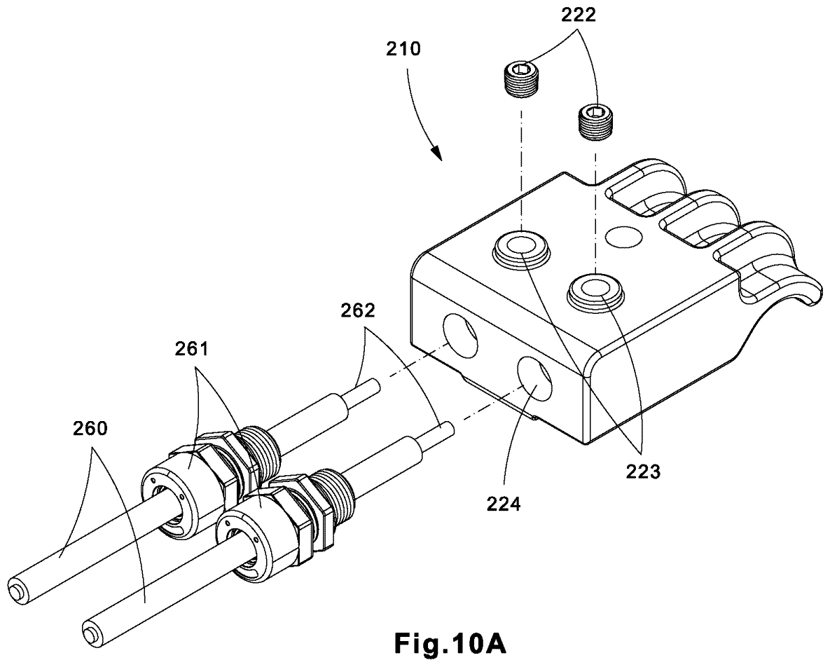

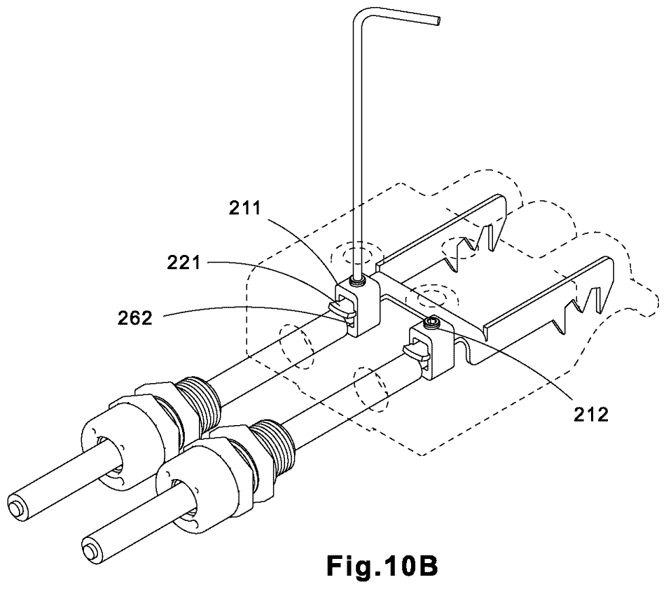

The components of the enclosure 210 are sized to allow for up to 6 AWG code wire. Provisions for a plurality (e.g., at least two) independent tap wires 260 to be attached to the enclosure 210 are included in the connector. FIG. 10A shows a first step of installing the tap wires 260 onto the enclosure 210. First, cable glands 261 (e.g., ⅜ NPT cable glands) on the tap wires 260 are removed, as well as pipe plugs 222 (e.g., ¼ NPT pipe plugs) removed from corresponding openings 223 in the enclosure 210. Then, the cable glands 261 are slid over the tap wires 260 so that the tap wires are run through the internal cavity of the cable glands 261. Then on the one end that will be inserted into tapped holes 224 in the enclosure 210, a portion of the insulation on the tapped wires 260 is removed to expose the wire conductor 262.

The stripped conductor 262 is then inserted into the tapped holes 224 and installed into respective terminal blocks 211, as shown in FIG. 10B. The stripped conductor 262 in positioned within the opening of the terminal blocks 211 along with the insertion tabs 221 of the insulation piercing blades 220. Then with a tool, e.g., a 3/32″ allen wrench, tighten the set screws 212, clockwise, in the terminal blocks 211 to a predetermined torque amount (e.g., 10 in-oz). Tightening the set screws 212 in this way ensure the stripped conductor 262 and the insertion tabs 221 of the insulation piercing blades 220 will be in electrical contact with each other within the opening of the terminal block 211. Then replace and tighten the pipe plugs 222 into their openings 223. Then reinstall and secure the cable glands 261. This process is repeated for the number of tap wires 260 being installed.

As is readily apparent from the foregoing, various non-limiting exemplary embodiments of an insulation piercing connector have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. An insulation piercing connector comprising:
an enclosure comprising a first opening positioned at a first location, a second opening positioned at a second location, the enclosure configured to house:
an insulation piercing blade assembly including a blade and a tab, wherein the blade is configured to protrude out the first opening; and
a terminal block being electrically coupled to the tab of the insulation piercing blade, the terminal block including a port opening aligned with the second opening and configured to receive a conductor wire from a tap cable inserted through the second opening; and
a cable clamp configured to be removably attached to the enclosure and form a main cable pathway with the enclosure for holding a main cable, wherein the blade is configured to protrude out the first opening and pierce an insulation jacket of main cable held within the main cable pathway.

2. The insulation piercing connector of claim 1, the enclosure further comprising:
a third opening including a threaded channel formed from the third opening.

3. The insulation piercing connector of claim 2, further comprising:
a set screw configured to be rotatably threaded down the threaded channel to abut against a conductor wire held in the terminal block.

4. The insulation piercing connector of claim 3, wherein the second opening is directed perpendicular to the third opening.

5. The insulation piercing connector of claim 1, the enclosure further comprising first fastener opening;
the cable clamp further comprising a second fastener opening; and
the insulation piercing connector further comprising a fastener configured to passthrough the first fastener opening and the second fastener opening to clamp the cable clamp together with the enclosure.

6. The insulation piercing connector of claim 5, wherein the fastener includes a handle at a first end.

7. The insulation piercing connector of claim 5, wherein the fastener includes a handle at a first end and a threaded portion at a second end for a nut to be threaded on.

8. The insulation piercing connector of claim 1, wherein the main cable pathway is configured to hold a main cable having a thickness of 6 AWG.

9. The insulation piercing connector of claim 1, wherein the tap cable has a thickness of 8 AWG or smaller.

10. The insulation piercing connector of claim 1, wherein the main cable is configured to carry up to 600 V.

11. The insulation piercing connector of claim 1, wherein the main cable is configured to carry up to 1000 V.

12. The insulation piercing connector of claim 1, wherein the main cable is configured to carry up to 2000 V.

13. The insulation piercing connector of claim 1, the enclosure further comprising a seal for covering, at least in part, the first opening.
